(19) United States
(12) Patent Application Publication
(10) Pub. No.: US 2006/0016659 A1
(43) Pub. Date: Jan. 26, 2006

(54) One-way clutch

(75) Inventor: Kazuhiko Muramatsu, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 11/183,891

(22) Filed: Jul. 19, 2005

(30) Foreign Application Priority Data
Jul. 21, 2004 (JP) 2004-212673

(51) Int. Cl. F16D 41/07

(52) U.S. Cl. 192/45.1

(57) ABSTRACT

In a one-way clutch comprising an inner ring and an outer ring radially spaced apart from each other, and disposed concentrically with each other for rotation relative to each other and having annular raceway surfaces, a torque transmitting member disposed between the inner ring and the outer ring for transmitting torque between the raceway surfaces, a holder for holding the torque transmitting member equally in the circumferential direction thereof, and an end bearing disposed between the inner ring and the outer ring for holding the inner ring and the outer ring in a concentric state, the end bearing is provided with a cut-away at a circumferential predetermined location thereon, the holder is disposed in the end bearing, and is provided with a projection abutting against the outer ring to give drag torque to the outer ring, and the projection protrudes from the cut-away.

### BACKGROUND OF THE INVENTION

1. Field of the Invention

This invention relates to a one-way clutch for a torque converter used as a part for torque transmission, backstop or the like, for example, in the driving apparatus of an automobile or the like, and more particularly to improvements in the end bearing of the one-way clutch.

2. Related Background Art

When a one-way clutch is incorporated and used in the rotating portion of an industrial machine or the like, it is held with constant drag torque given to an outer ring or an inner ring which is a rotating member so that the function thereof may not be spoiled by vibration, inertia, etc.

For example, when there is sudden acceleration or deceleration in the rotation of the outer ring, a sprag slides on the raceway surface of the outer ring due to inertia and causes friction and therefore, it is necessary to provide a frictional force, i.e., drag torque, between an outer holder and the outer ring to thereby rotate the one-way clutch always integrally with the rotating outer ring. This is for transmitting the movement of the outer ring quickly to the outer holder and also, ensuring the movement of the sprag.

In order to obtain the constant drag torque as described above, in a conventional one-way clutch, the outer holder has been subjected to cutting-away work, i.e., T-bar working or i-bar working, or as a discrete member, a spring member such as a drag clip has been attached to the outer holder. Also, since such problems as the working property and an increase in constituent parts arise, there has been proposed a means for making the flange portion of the outer holder into an elliptical shape.

For example, Japanese Utility Model Application Laid-Open No. S60-127128 discloses a construction in which a part or the whole of the holding surface of a holder is cut away to thereby provide a flat portion abutting against the annular inner surface of an outer ring, and necessary drag torque is obtained by this flat portion.

Japanese Utility Model Application Laid-Open No. H5-54831 discloses a construction in which a projection extending radially outwardly is formed on a portion of the flange of a holder, and this projection is made to abut against the annular inner surface of an outer ring to thereby obtain necessary drag torque.

However, the above-described conventional one-way clutches have suffered from the following problem. Generally, in a one-way clutch for a torque converter, it is often the case that bushes made of a bearing alloy are disposed in parallel at the axial opposite ends thereof and are used as the bearings of inner and outer rings. In this case, correspondingly to the bushes, the axial length of the entire one-way clutch has often become great. Accordingly, there is a design in which an end bearing is used instead of the bushes to thereby shorten the axial length.

The end bearing is provided with a flange portion axially extending from the inner diameter and outer diameter of an annular plate member. This flange portion has a bearing function to the inner and outer rings. Consequently, in order that the flange portion of a holder may directly give drag torque to the outer ring, it is necessary to detach the end bearing from the flange portion, and this has led to the problem that the axial length becomes correspondingly great.

### SUMMARY OF THE INVENTION

Accordingly, it is the object of the present invention to provide a one-way clutch for a torque converter which is provided with an end bearing, and which can obtain stable drag torque and which is simple in construction and can be shortened in the axial length thereof.

In order to achieve the above object, the one-way clutch of the present invention is a one-way clutch comprising an inner ring and an outer ring radially spaced apart form each other and disposed concentrically with each other for rotation relative to each other, and having annular raceway surfaces, a torque transmitting member disposed between the inner ring and the outer ring for transmitting torque between the raceway surfaces, a holder for holding the torque transmitting member equally in the circumferential direction thereof, and an end bearing disposed between the inner ring and the outer ring for holding the inner ring and the outer ring in a concentric state, wherein the end bearing is provided with a cut-away at a circumferential predetermined location thereon, the holder is disposed in the end bearing, and is provided with a projection abutting against the outer ring to give drag torque to the outer ring, and the projection protrudes from the cut-away.

According to the present invention, there is obtained the following effect.

From the cut-away provided on the end bearing, the projection of the holder contacts with the outer ring and gives drag torque to the outer ring. There can be provided a one-way clutch in which stable drag torque is obtained by a simple construction and by the utilization of the elastic deformation of the holder and which is free of the possibility of a reduced life. Because of simple structure, dimensional control becomes easy and machining is also easy. The projection is only provided on the flange portion of the holder and therefore, without the number of working steps being increased and without any reduction in strength, there can be provided a one-way clutch which is low in manufacturing cost and improved in life.

The end bearing is provided with a cut-away at a circumferential predetermined location thereon, and the holder is disposed in the end bearing, and is provided with a projection abutting against the outer ring or the inner ring to give drag torque to the inner ring or the outer ring, and the projection protrudes from the cut-away.

### BRIEF DESCRIPTION OF THE DRAWINGS

FIG. 1 is a partly broken-away front view of a one-way clutch according to an embodiment of the present invention.

FIG. 2 is an axial cross-sectional view of the one-way clutch of FIG. 1.

FIG. 3 is a front view of the one-way clutch according to the embodiment of the present invention showing the relation between an outer holder and an end bearing.

FIG. 4 is a partly broken-away top plan view of the one-way clutch according to the embodiment of the present invention.

### DESCRIPTION OF THE PREFERRED EMBODIMENTS

The present invention will hereinafter be described in detail with reference to the drawings. The embodiment hereinafter described illustratively describes the present invention, and of course does not restrict the present invention. Also, in the drawings, like portions are designated by like reference characters.

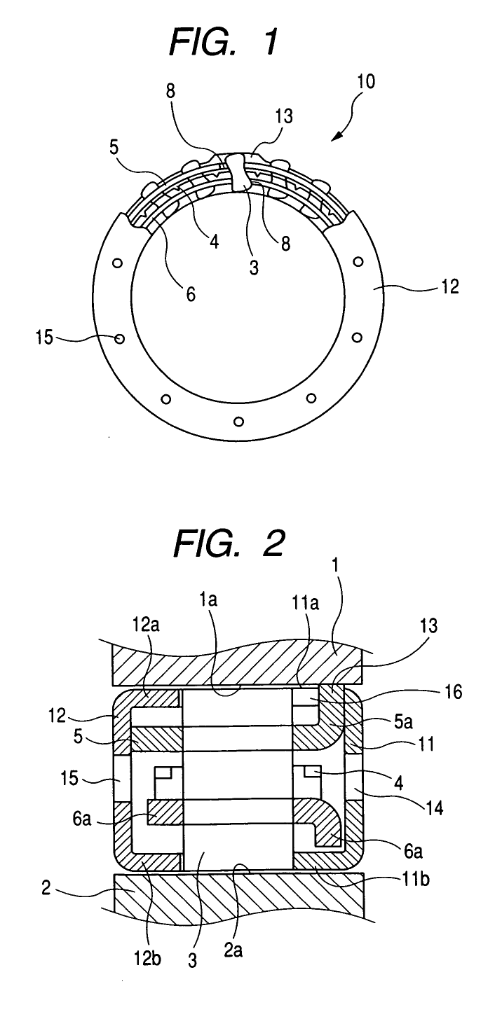

FIG. 1 is a partly broken-away front view of a one-way clutch 10 according to an embodiment of the present invention, and FIG. 2 is an axial cross-sectional view of the one-way clutch 10 of FIG. 1. A torque transmitting member is shown as an example using a ground-shaped sprag, but the present invention can also be applied to other form of one-way clutch. In FIG. 1, an outer ring 1, an inner ring 2 and an end bearing 11 are not shown.

Referring to FIG. 2, the outer ring 1 is provided with a substantially circular inner peripheral surface 1a. Also, the inner ring 2 is a substantially circular outer peripheral surface 2a. The outer ring 1 and the inner ring 2 are rotatable relative to each other with the inner peripheral surface 1a and the outer peripheral surface 2a opposed to each other.

In an annular space defined by the outer ring 1 and the inner ring 2, a plurality of torque transmitting members, i.e., ground-shaped sprags 3, for transmitting torque between the two rings are disposed at equal intervals in the circumferential direction thereof, and transmit torque between the outer and inner rings. The sprags 3 are held in substantially rectangular windows 8 provided in a pair of holders, i.e., an outer holder 5 and an inner holder 6. A ribbon spring 4 is disposed between the outer and inner holders 5 and 6, and gives the sprags 3 a rising moment in a direction to mesh with an engagement surface.

As is apparent from FIG. 1, the annular inner holder 6 having a substantially circular inner diameter has on one axial end portion thereof an annular flange portion 6a extending substantially vertically, i.e., radially inwardly, by a predetermined distance, and the distal end portion of the flange portion 6a is opposed to the inside of the inner diameter of an end bearing with a predetermined clearance therebetween.

Also, the annular outer holder 5 having a substantially circular inner diameter has on one axial end portion thereof an annular flange portion 5a extending substantially vertically, i.e., radially outwardly, by a predetermined distance, and the distal end portion of the flange portion 5a is opposed to the inside of the outer diameter of the end bearing with a predetermined clearance therebetween.

FIG. 2 is an axial cross-sectional view of the one-way clutch 10 of FIG. 1, and shows the details of the one-way clutch 10. The one-way clutch 10 has substantially annular end bearings 11 and 12 provided on the axial end portions thereof and between the inner ring 2 and the outer ring 1. The end bearings 11 and 12 are disposed between the inner ring 2 and the outer ring 1, and hold the inner ring 2 and the outer ring 1 in a concentric state. That is, they perform the function of the bearings of the inner and outer rings.

The end bearings 11 and 12 are engaged with the inner peripheral surface 1a of the outer ring 1 with a predetermined clearance therebetween, that is, loosely fitted to the inner peripheral surface 1a. The end bearings 11 and 12 are provided with flange portions 11a, 11b and 12a, 12b, respectively, extending axially inwardly from the outer diameter side and the inner diameter side. Accordingly, on the outer peripheral surfaces of the flange portions 11a and 12a, they are loosely fitted to the inner peripheral surface 1a of the outer ring 1. Also, the outer peripheries of the flange portions 11b and 12b are slidably opposed to the outer periphery 2a of the inner ring 2 with a predetermined clearance therebetween.

The end bearings 11 and 12 are provided with a plurality of through-holes 14 and 15 formed at equal intervals in the circumferential direction thereof and axially extending therethrough. These through-holes 14 and 15 provide routes for lubricating oil for lubricating the one-way clutch 10.

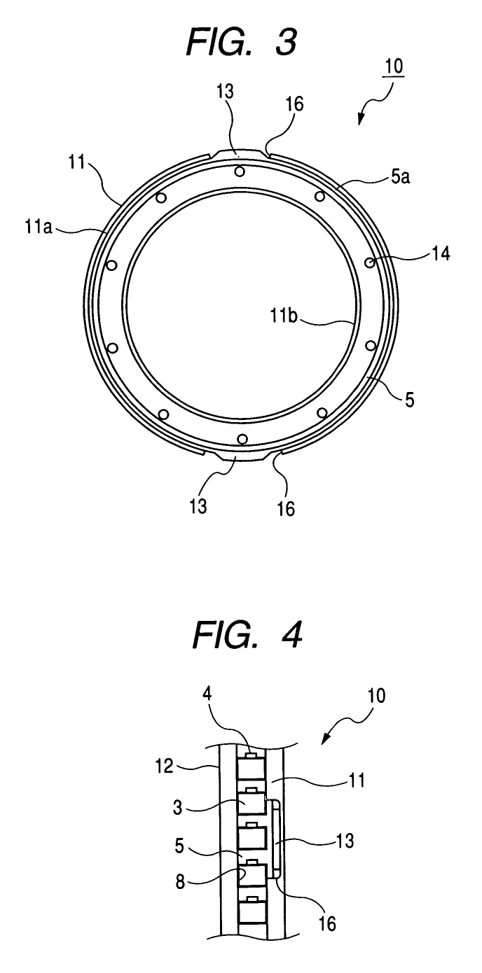

As shown in FIGS. 1 and 2, the flange portion 5a of the outer holder 5 is provided with projections 13 on circumferential portions thereof. Also, the end bearing 11 is provided with cut-aways 16 at circumferential predetermined locations thereon. In the present embodiment, as shown in FIG. 3, the projection 13 and the cut-away 16 are provided at two locations opposed to each other at phases differing by about 180 degrees from each other. Also, the outer holder 5 is disposed in the end bearings 11 and 12, and is provided with the projection 13. The projections 13 protrude from the cut-aways 16 toward the outer diameter side, and abut against the inner peripheral surface 1a of the outer ring 1 to thereby give necessary drag torque to the outer ring 1.

FIG. 3 is a front view of the one-way clutch according to the embodiment of the present invention, and shows the relation between the outer holder 5 and the end bearings. The sprags 3 and the ribbon spring 4 are not shown in this figure. It will be seen that the two projections 13 of the outer holder 5 are provided at phases differing by about 180 degrees from each other.

FIG. 4 is a partly broken-away top plan view of the one-way clutch according to the embodiment of the present invention. It shows the relation between the cut-aways 16 of the end bearing 11 and the projections 13 provided on the flange portion 5a of the outer holder 5. The circumferential width of the projections 13 is smaller than the circumferential width of the cut-aways 16. Therefore, the projections 13 are movable relative to and in the cut-aways 16. The cut-aways 16 are formed by cutting away from the end surface of the outer flange portion 11a of the end bearing 11 toward the annular surface thereof.

As described above, the necessary drag torque can be given to the outer ring 1 by the two projections 13 provided on the flange portion 5a of the outer holder 5 protruding from the cut-aways 16 of the end bearing 11 and abutting against the inner peripheral surface 1a of the outer ring 1, and the outer holder 5 being elastically deformed.

It is preferable that the number of the projections 13 be two, but if required, one or a plurality of projections 13 can be provided. Also, in order to more effectively give elastic deformation to the projections 13, the cylindrical portion of the outer holder 5 may be formed into an elliptical shape.

In the above-described embodiment, projections are provided on the substantially circular flange portion 5a, and by the utilization of the elastic deformation of the holder, the projections are made to abut against the inner peripheral surface 1a of the outer ring 1 and as a result, a pressure force is made to act on the outer ring 1 to thereby produce stable drag torque to the outer ring 1.

While in the description of the above-described embodiment, the one-way clutch has been described as having two holders, i.e., the outer holder and the inner holder, of course the present invention can also be applied to a one-way clutch of a type having only one holder.

This application claims priority from Japanese Patent Application No. 2004-212673 filed on Jul. 21, 2004, which is hereby incorporated by reference herein.

What is claimed is:

1. A one-way clutch comprising an inner ring and an outer ring radially spaced apart from each other, and disposed concentrically with each other for rotation relative to each other and having annular raceway surfaces, a torque transmitting member disposed between said inner ring and said outer ring for transmitting torque between said raceway surfaces, a holder for holding said torque transmitting member equally in the circumferential direction thereof, and an end bearing disposed between said inner ring and said outer ring for holding said inner ring and said outer ring in a concentric state, wherein said end bearing is provided with a cut-away at a circumferential predetermined location thereon, said holder is disposed in said end bearing, and is provided with a projection abutting against said outer ring to give drag torque to said inner ring or said outer ring, and said projection protrudes from said cut-away.
